(19) United States
(12) Patent Application Publication
(10) Pub. No.: US 2002/0099624 A1
(43) Pub. Date: Jul. 25, 2002

(54) Marketing system for upscale items

(76) Inventor: Norwood P. Dixon JR., Volente, TX (US)

Correspondence Address: Michael A. O'Neil, Michael A. O'Neil, P.C., 5949 Sherry Lane, Suite 1030, Dallas, TX, 75225, US

(21) Appl. No.: 09/767,270

(22) Filed: Jan. 22, 2001

Related U.S. Application Data
(60) Provisional application No. 60/177,851, filed on Jan. 24, 2000.

(51) Int. Cl. G06F 17/60

(52) U.S. Cl. 705/27; 705/1

(57) ABSTRACT

Upscale merchandise items are screened in accordance with predetermined personality profile and interest profile criteria. Prospective customers are likewise identified using the personality profile and interest profile criteria. Merchandise items are matched with prospective customers in accordance with the personality profile and interest profile criteria whereupon the prospective customer is made aware of the identified merchandise items.

### TECHNICAL FIELD

This invention relates generally to a system for marketing upscale, i.e., higher priced merchandise items, and more particularly to a system for providing prospective customers with information concerning upscale items available from vendors located throughout the world.

### BACKGROUND AND SUMMARY OF THE INVENTION

At the present time, prospective purchasers of higher priced merchandise are limited to three selection modalities. The first is to visit one or more retail outlets which carry particular types of merchandise. In most instances the selection of merchandise from retail stores is limited to particular cities or regions due to considerations of time and expense.

The second option available to purchasers of designated types of merchandise involves the use of catalogs and similar publications which are mass mailed to prospective purchasers. In some instances, attempts are made to direct catalogs to specific purchasers based on prior purchasing profiles. Such attempts have met with limited success in the merchandising of upscale items, possibly because by their very nature catalogs must include a wide variety of items and therefore cannot be tailored to the requirements of specific individuals.

The third possibility for selecting high end merchandise involves the use of the internet or the world wide web. With the ever increasing number of internet addresses and web sites identified with vendors of upscale merchandise, the process of selecting particular merchandise items utilizing the internet or the world wide web has become increasingly frustrating.

The present invention overcomes the foregoing difficulties to provide a system for making preselected upscale merchandise items available to prospective customers with a minimum of difficulty. In accordance with the broader aspects of the invention, merchandise items available from vendors located throughout the world are screened by a reviewing panel in accordance with predetermined personality profile and predetermined interest profile characteristics. Prospective purchasers are likewise categorized using the personality profile and the interest profile.

Available merchandise items are matched to the personality and the interests of each set prospective purchaser profile. Initially the prospective customer is provided with limited information as to each selected merchandise item. The prospective customer makes preliminary selections from the initial list of merchandise items, after which detailed information for each merchandise item is prepared and presented to the customer for final selection.

### BRIEF DESCRIPTION OF THE DRAWINGS

A more complete understanding of the invention may be had by reference to the following Detailed Description when taken in conjunction with the accompanying Drawings, wherein:

FIG. 1 is a flow chart detailing the merchandise selection process of the invention;

FIG. 2 is a flow chart detailing the process for categorizing the personality and interests of the perspective customer; and

FIG. 3 is a flow chart detailing the procedure for presenting merchandise items which match the personality profile and interest profile of the prospective customer.

### DETAILED DESCRIPTION

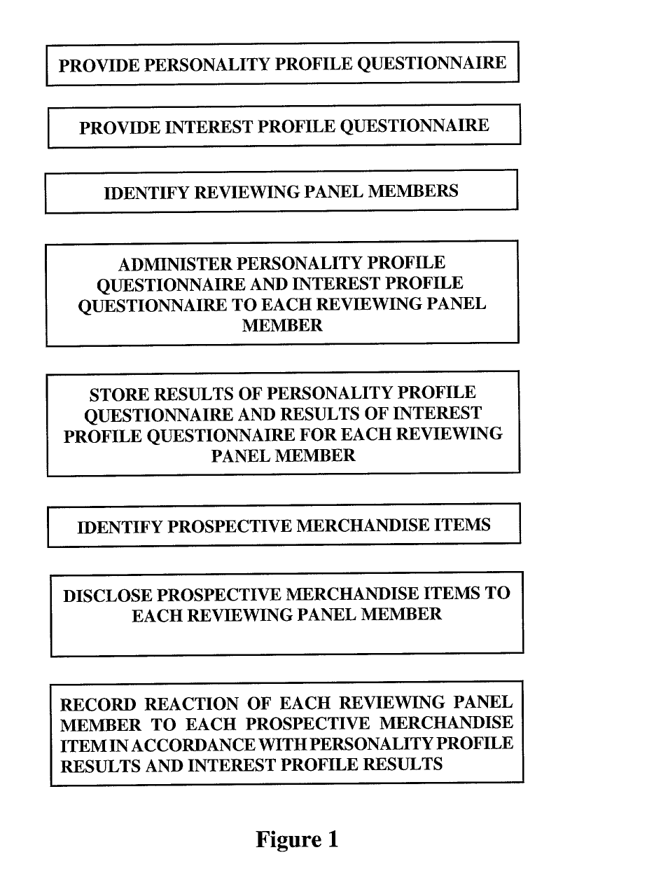

Referring now to the Drawings, and particularly to FIG. 1 thereof, in accordance with the present invention there is provided a personality profile questionnaire and an interest profile questionnaire. Members of a reviewing panel are identified, and each member of the reviewing panel completes the personality profile questionnaire and the interest profile questionnaire. The personality profile results and the interest profile results for each reviewing panel member are stored, typically in a computer. Each reviewing panel member rates each of the prospective merchandise items in accordance with a preselected scale or rating system. The reaction of each reviewing panel member to each prospective merchandise item is processed in accordance with the personality profile results and the interest profile results of the reviewing panel member. The result is an array of values for the individual item. The profile (consisting of interests and personality) for the search is processed against the inventory of all arrays.

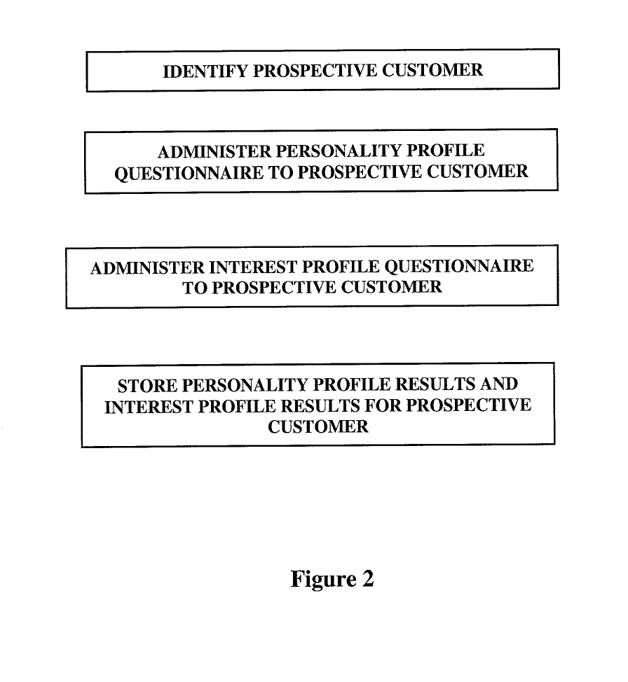

Referring to FIG. 2, prospective customers are identified. Each prospective customer completes the personality profile questionnaire and the interest profile questionnaire. The personality profile results and the interest profile results are processed against the inventory of arrays described above.

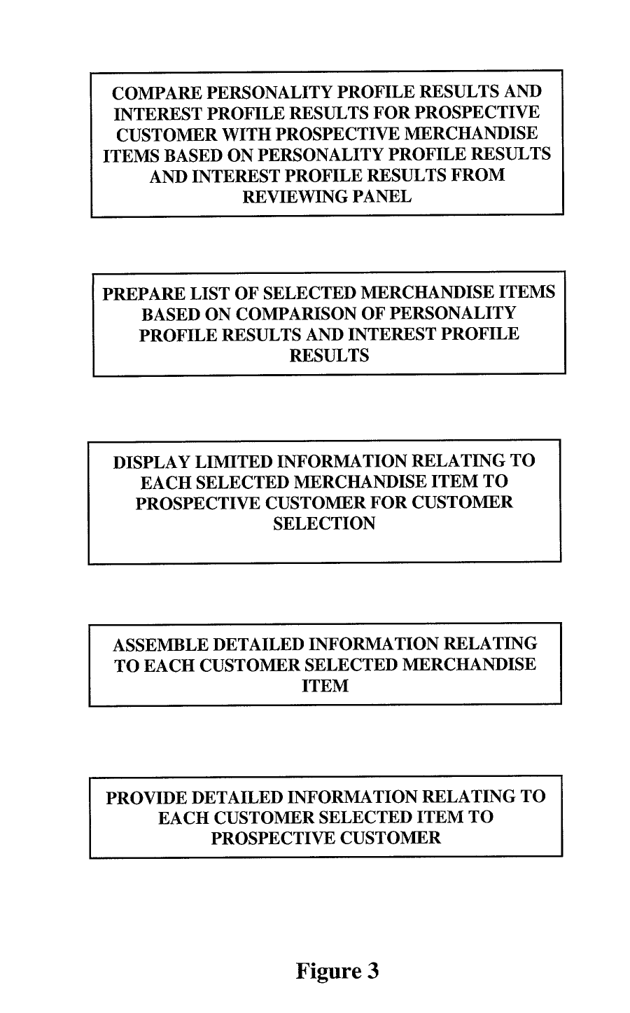

Referring to FIG. 3, the personality profile results and the interest profile results for each prospective customer are matched with prospective merchandise items based on the personality profile results and the interest profile results from the reviewing panel. The comparison of the personality profile results and interest profile results relating to specific prospective merchandise items is utilized to prepare a list of selected merchandise items which is matched to the personality profile result and interest profile result of a particular customer.

The prospective customer is provided with a list of selected merchandise items which have been pre-screened by the system using the profile against the inventory of arrays and matched to the customer's personality and interest traits. From the initial list the customer selects a substantially smaller number of items in which there is genuine purchase interest. The prospective customer is thereafter provided detailed information, in the form of color photographs, written descriptions, etc., as to each customer selected item. Preferably both the initial list and the detailed information are provided to the customer electronically, such as via the internet. At this point the customer has available for purchase items from retailers throughout the world which have been specifically selected in accordance with the customer's personality and interest.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of merchandising upscale items comprising the steps of:
providing personality and interest profile criteria;
categorizing available merchandise items in accordance with the personality and interest profile criteria;
categorizing prospective customers in accordance with the personality profile and interest profile criteria;
matching selected merchandise with selected prospective customers in accordance with the personality profile and interest profile criteria; and
identifying the selected merchandise items to the prospective customer.
